(19) United States
(12) Patent Application Publication
(10) Pub. No.: US 2014/0026926 A1
(43) Pub. Date: Jan. 30, 2014

(54) METHOD AND APPARATUS FOR LIQUID TREATMENT OF WAFER-SHAPED ARTICLES

(71) Applicants: Christoph SEMMELROCK, KLAGENFURT (AT); Michael PUGGL, VILLACH (AT); Anders Joel BJOERK, VILLACH (AT); Karl-Heinz HOHENWARTER, DELLACH/GAIL (AT)

(72) Inventors: Christoph SEMMELROCK, KLAGENFURT (AT); Michael PUGGL, VILLACH (AT); Anders Joel BJOERK, VILLACH (AT); Karl-Heinz HOHENWARTER, DELLACH/GAIL (AT)

(73) Assignee: LAM RESEARCH AG, VILLACH (AT)

(21) Appl. No.: 13/562,103

(22) Filed: Jul. 30, 2012

(51) Int. Cl. B08B 3/10

(52) U.S. Cl. 134/30; 134/95.2

(57) ABSTRACT

An apparatus and method for treating a wafer-shaped article utilizes a gas supply hood that can be positioned in a working position above a holder so as to cover all or substantially all of a wafer shaped article when positioned on the holder. The gas supply hood accommodates a fluid dispenser for dispensing at least one fluid onto an upper surface of the wafer shaped article positioned on the holder. The gas supply hood permits the fluid dispenser to be moved laterally of the holder and the gas supply hood while the gas supply hood is in the working position and without moving the gas supply hood.

### BACKGROUND OF THE INVENTION

1. Field of the Invention

The invention relates generally to methods and apparatus for liquid treatment of wafer-shaped articles, such as semiconductor wafers, wherein one or more process liquids are dispensed onto a surface of the wafer-shaped article.

2. Description of Related Art

Semiconductor wafers are subjected to various surface treatment processes such as etching, cleaning, polishing and material deposition. To accommodate such processes, a single wafer may be supported in relation to one or more treatment fluid nozzles by a chuck associated with a rotatable carrier, as is described for example in U.S. Pat. Nos. 4,903,717 and 5,513,668.

With increasing miniaturization of devices and features fabricated on semiconductor wafers, processing those wafers in an uncontrolled open environment becomes more problematic. For example, when wafers undergo wet processing in stations that are open to the surrounding air, the oxygen content of the air causes unwanted corrosion of copper on the front side of the wafer.

During processing of a single wafer in an open environment the oxygen from the air can diffuse through the liquid layer on the wafer to the wafer surface, leading to copper oxidation and therefore copper loss, a phenomenon which also affects others metal layers such as cobalt. This effect is enhanced where the liquid layer is very thin, e.g. at the wafer edge.

Furthermore, mechanical and fluid forces acting across the surface of a wafer during processing in an uncontrolled open environment can lead to pattern collapse, distortion or other damage to various devices and features fabricated on the surface of the wafer.

Pattern collapse can occur, for example, when the surface tension of a liquid moving radially outwardly across the surface of a rotating wafer applies a damaging or destructive force to the submicroscopic structures formed on the wafer surface. The problem of pattern collapse becomes more serious as the diameter of semiconductor wafers increases and as the aspect ratio of the submicroscopic structures increases.

The application and removal of treatment liquids in an uncontrolled open environment also leads to the creation of watermarks on the surface of the wafer.

On the other hand, a wafer processing tool provided with an environmentally sealed chamber typically requires a larger capital investment and is also costlier and more complicated to operate than an open processing tool.

Previous attempts to provide a locally controlled gaseous ambient within an open wafer processing tool have not been fully satisfactory. For example, U.S. Pat. No. 6,193,798 describes a chuck provided with a stationary nitrogen hood; however, the nozzles for dispensing treatment fluid are fixed in the hood, and thus cannot move in relation to the wafer. Commonly-owned co-pending U.S. application Pub. No. 2012/0131815 describes a gas dispenser that is small in relation to the diameter of the workpiece, and which includes a central fluid dispenser. The gas dispenser and fluid dispenser can thus be moved together, but not independently, and motion of both is necessary to treat the entire wafer surface.

### SUMMARY OF THE INVENTION

Thus, in one aspect, the present invention relates to an apparatus for treating a wafer-shaped article, comprising a holder for holding a wafer-shaped article of a predetermined diameter, a fluid dispenser for dispensing at least one fluid onto an upper surface of a wafer shaped article positioned on the holder, and a gas supply device positionable in a working position above the holder wherein the gas supply device covers all or substantially all of a wafer shaped article when positioned on the holder. The gas supply device accommodates the fluid dispenser within a gas supply hood and permits the fluid dispenser to be moved laterally of the holder and the gas supply hood while the gas supply hood is in the working position and without moving the gas supply hood.

In preferred embodiments of the apparatus according to the invention, the gas supply device comprises a gas showerhead having an array of gas dispensing outlets directed downwardly toward a wafer-shaped article when position on the holder.

In preferred embodiments of the apparatus according to the invention, the holder is a spin chuck in a process module for single wafer wet processing of semiconductor wafers.

In preferred embodiments of the apparatus according to the invention, a fluid collector surrounds the holder, and the collector exposes the holder and the gas supply hood to ambient atmosphere.

In preferred embodiments of the apparatus according to the invention, the outer edge of the gas supply hood has a shape that corresponds to the inner edge of the fluid collector. Preferably the gap between the outer edge of the gas supply and the inner edge of the collector is in the range of 0.3 mm to 5 mm.

In preferred embodiments of the apparatus according to the invention, the gas supply hood covers an area that is 95% to 99% of the area surrounded by the collector.

In preferred embodiments of the apparatus according to the invention, the gas dispensing outlets each comprise an upstream opening communicating with a plenum formed within the gas showerhead and a downstream opening facing the holder, and the gas dispensing outlets increase in cross-sectional area from the upstream opening to the downstream opening.

In preferred embodiments of the apparatus according to the invention, the downstream openings of the gas dispensing outlets are defined by a honeycomb pattern of a dispensing face of the gas showerhead.

In preferred embodiments of the apparatus according to the invention, the gas supply hood is mounted for pivotal movement between the working position and a standby position.

In preferred embodiments of the apparatus according to the invention, the gas supply hood further comprises a tunnel defined by a pair of walls whose upper ends are joined together and whose lower ends pass through a distribution plate of the gas showerhead, wherein a first one of the lower ends terminates at or adjacent a lowermost edge of the gas supply hood and wherein a second one of the lower ends terminates a predetermined distance above the first lower end, whereby the tunnel has an asymmetric shape.

In preferred embodiments of the apparatus according to the invention, the gas supply device comprises at least one first external inlet supplying gas to the gas showerhead and at least one second external inlet separately supplying gas to the tunnel.

In preferred embodiments of the apparatus according to the invention, the apparatus includes computer-controlled valves configured to control a flow rate of gas into the gas showerhead and a flow rate of gas into the tunnel independently one another.

In preferred embodiments of the apparatus according to the invention, the tunnel comprises a gas inlet positioned on an exterior surface of the gas supply hood and communicating with a plenum formed inside a wall of the tunnel, the tunnel further comprising an array of gas outlets formed in at least one interior wall of the tunnel and communicating with the plenum.

In preferred embodiments of the apparatus according to the invention, the tunnel further comprises an array of gas inlets formed in at least one interior wall of the tunnel and communicating with an array of gas outlets formed in at least one exterior wall of the tunnel.

In preferred embodiments of the apparatus according to the invention, the tunnel comprises a horizontal row of gas outlets formed in each of two opposing interior walls of the tunnel, the horizontal rows of gas outlets facing one another.

In preferred embodiments of the apparatus according to the invention, the fluid dispenser is mounted for lateral movement in a plane perpendicular to the axis of rotation of the spin chuck.

In preferred embodiments of the apparatus according to the invention, the lateral movement is linear movement along a radial direction of the spin chuck.

In preferred embodiments of the apparatus according to the invention, the lateral movement is swinging movement and the fluid dispenser comprises a proximal end mounted for pivotal movement about an axis parallel to and offset from the axis of rotation of the spin chuck and a distal end that is moveable over a circular arc.

In preferred embodiments of the apparatus according to the invention, a second fluid dispenser is accommodated beneath the gas supply hood and comprises a proximal end mounted for pivotal movement about an axis parallel to and offset from the axis of rotation of the spin chuck and the pivot axis of said fluid dispenser, and a distal end that is moveable over a circular arc.

In preferred embodiments of the apparatus according to the invention, the fluid dispenser is a drying unit supplied with deionized water.

In preferred embodiments of the apparatus according to the invention, the drying unit is further supplied with isopropyl alcohol and gaseous nitrogen, and is configured to perform Marangoni drying of a rotating wafer-shaped article.

In another aspect, the present invention relates to a gas supply device for use in an apparatus for treating wafer-shaped articles of a predetermined diameter, comprising a gas showerhead of a size to cover all or substantially all of a wafer-shaped article when mounted on an apparatus for treating wafer-shaped articles and when in a working position. A pivotal mounting for the gas showerhead permits the gas showerhead to move between the working position and a standby position. The gas supply device is configured to receive a fluid dispenser within an outlet side of the gas showerhead such that the fluid dispenser is moveable laterally of the gas showerhead.

In preferred embodiments of the gas supply device according to the invention, a tunnel projects upwardly from the gas showerhead and is configured to accommodate a fluid dispenser such that the fluid dispenser is linearly movable within the tunnel.

In preferred embodiments of the gas supply device according to the invention, the gas showerhead comprises a fluid dispenser pivotally mounted on an outlet side of the gas showerhead.

In preferred embodiments of the gas supply device according to the invention, the gas showerhead comprises two fluid dispensers each pivotally mounted on a respective opposite peripheral region of an outlet side of the gas showerhead.

In preferred embodiments of the gas supply device according to the invention, the gas showerhead comprises an array of gas dispensing outlets directed toward an outlet side of the gas showerhead.

In preferred embodiments of the gas supply device according to the invention, the gas dispensing outlets each comprise an upstream opening communicating with a plenum defined by the gas showerhead and a downstream opening on the outlet side, and wherein the gas dispensing outlets increase in cross-sectional area from the upstream opening to the downstream opening.

In preferred embodiments of the gas supply device according to the invention, the downstream openings of the gas dispensing outlets are defined by a honeycomb pattern of a dispensing face of the gas showerhead.

In preferred embodiments of the gas supply device according to the invention, the tunnel comprises a gas inlet positioned on an exterior surface of the gas supply hood and communicating with a plenum formed inside a wall of the tunnel, the tunnel further comprising an array of gas outlets formed in at least one interior wall of the tunnel and communicating with the plenum.

In preferred embodiments of the gas supply device according to the invention, the tunnel further comprises an array of gas inlets formed in at least one interior wall of the tunnel and communicating with an array of gas outlets formed in at least one exterior wall of the tunnel.

In preferred embodiments of the gas supply device according to the invention, the tunnel comprises a horizontal row of gas outlets formed in each of two opposing interior walls of the tunnel, the horizontal rows of gas outlets facing one another.

In another aspect, the present invention relates to a method of treating a wafer-shaped article, comprising positioning a wafer-shaped article of a predetermined diameter on a holder, positioning a gas supply hood in a working position above the holder wherein the gas supply hood covers all or substantially all of the wafer-shaped article positioned on the holder, and also covers a dispensing portion of a fluid dispenser for dispensing at least one fluid onto an upper surface of the wafer shaped article, dispensing a non-oxidizing gas through the gas supply hood to purge a local ambient above the wafer-shaped article, and moving the fluid dispenser laterally of the holder and the gas supply hood while maintaining the gas supply hood stationary relative to the holder.

In preferred embodiments of the method according to the invention, the positioning step comprises pivoting the gas supply hood from a standby position to the working position.

In preferred embodiments of the method according to the invention, the non-oxidizing gas is dispensed through the gas supply hood at a flow rate of 50-300 l/min.

In preferred embodiments of the method according to the invention, the fluid dispenser is mounted to a downwardly facing surface of the gas supply hood, and is moved in a lateral swinging pattern by a motor mounted on an upwardly facing surface of the gas supply hood.

In preferred embodiments of the method according to the invention, the fluid dispenser is mounted independently of the gas supply hood, and is moved laterally along a linear path within a tunnel that projects upwardly from the gas supply hood.

In preferred embodiments of the method according to the invention, the non-oxidizing gas is dispensed from the gas supply hood during lateral movement of the fluid dispenser within the gas supply hood.

In preferred embodiments of the method according to the invention, deionized water is dispensed from the fluid dispenser during the moving step.

In preferred embodiments of the method according to the invention, isopropyl alcohol and gaseous nitrogen are dispensed from the fluid dispenser during the moving step, so as to perform Marangoni drying of a rotating wafer-shaped article.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is a perspective view from above of a gas supply device according to a first embodiment of the present invention;

FIG. 2 is a perspective view from below of the gas supply device of FIG. 1;

FIG. 4 is a sectional view taken along the line IV-IV of FIG. 3;

FIG. 5 is a sectional view of the hood 10, taken along the line V-V of FIG. 3;

FIG. 6 is a top plan view of the gas supply device of FIG. 1 mounted on a spin chuck, with the gas supply hood in its working position and with a fluid dispenser of the spin chuck accommodated in the tunnel of the gas supply hood;

FIG. 7 is a sectional view taken along the line VII-VII of FIG. 6;

FIG. 8 is an enlargement of the detail VIII designated in FIG. 7;

FIG. 9a is a fragmentary sectional view of the gas distribution plate of the gas showerhead of the embodiment of FIG. 1;

FIG. 9b shows the pattern of inlet openings on the upstream face of the gas distribution plate of FIG. 9a;

FIG. 9c shows the pattern of outlet openings on the downstream face of the gas distribution plate of FIG. 9a;

FIG. 10 is a schematic axial cross-section through a gas supply hood according to another preferred embodiment of the present invention;

FIG. 11 is a bottom plan view of the gas supply hood of FIG. 10;

FIG. 12 is a schematic bottom plan view of a gas supply hood according to yet another preferred embodiment of the present invention; and

FIG. 13 is a schematic side view of the FIG. 12 embodiment in its standby position.

### DETAILED DESCRIPTION OF PREFERRED EMBODIMENTS

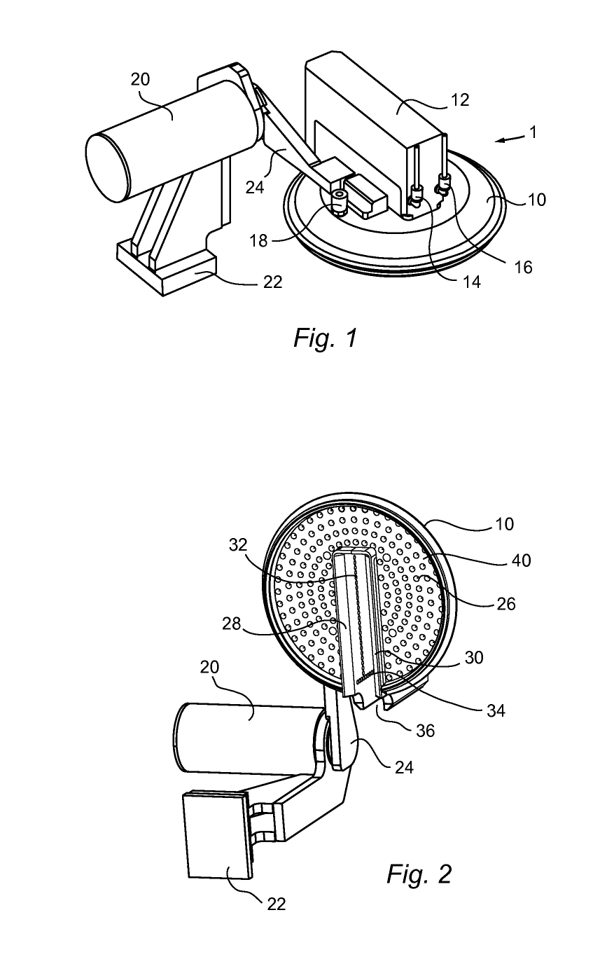

In FIG. 1, a gas supply device 1 according to a first embodiment of the present invention comprises a gas hood 10 that is mounted via a pivot link 24 to a motor 20. The overall device will be mounted via base plate 22 to an apparatus for treating wafer-shaped articles, and preferably to a spin chuck in a process module for single wafer wet processing of semiconductor wafers. The orientation of hood 10 to motor 20 and base plate 22 corresponds to the working position of the gas supply device 1, from whence it can be pivoted to a standby position by the action of motor 20 via pivot link 24.

The hood 10 includes a tunnel 12 that is built into the hood 10, and whose purpose will become apparent from the following description. Inlets 14 and 16 supply a non-oxidizing gas, preferably nitrogen, to the left and right side walls, respectively, of tunnel 12, whereas inlet 18 separately supplies non-oxidizing gas, which is also preferably nitrogen, to the gas showerhead 40 of hood 10.

Referring now to FIG. 2, it can be seen from the underside that hood 10 includes a gas showerhead 40 having a multiplicity of openings 26 formed in an array, for dispensing non-oxidizing gas downwardly onto the upper surface of a wafer-shaped article. Furthermore, the tunnel 12 as seen from below includes a pair of opposing walls 28, 30. On the interior surface of wall 28 can be seen a row of openings 32 and a perpendicular column of openings 34. Wall 30 has the same array of openings on its interior surface, although those openings are not visible in FIG. 2.

Openings 32, of which there are 25 in each tunnel wall 28, 30 in this embodiment, are outlets that communicate with inlet 14 via a plenum 38 formed interiorly of wall 28, and the corresponding openings in wall 30 communicate via a plenum in wall 30 with inlet 16. The plenum 38 is formed in the walls 28 and 30 and covered by the covers 28c and 30c. Openings 34, of which there are eight in each tunnel wall 28, 30 in this embodiment, are further outlets that communicate with plenum 38.

As can also be seen in FIG. 2, tunnel 12 is open at its back end, with the opening 36 there permitting the hood to fit over a fluid dispenser as well as to permit the fluid dispenser to move laterally relative to the hood 10, in a direction parallel to walls 28, 30, as will be described more fully below.

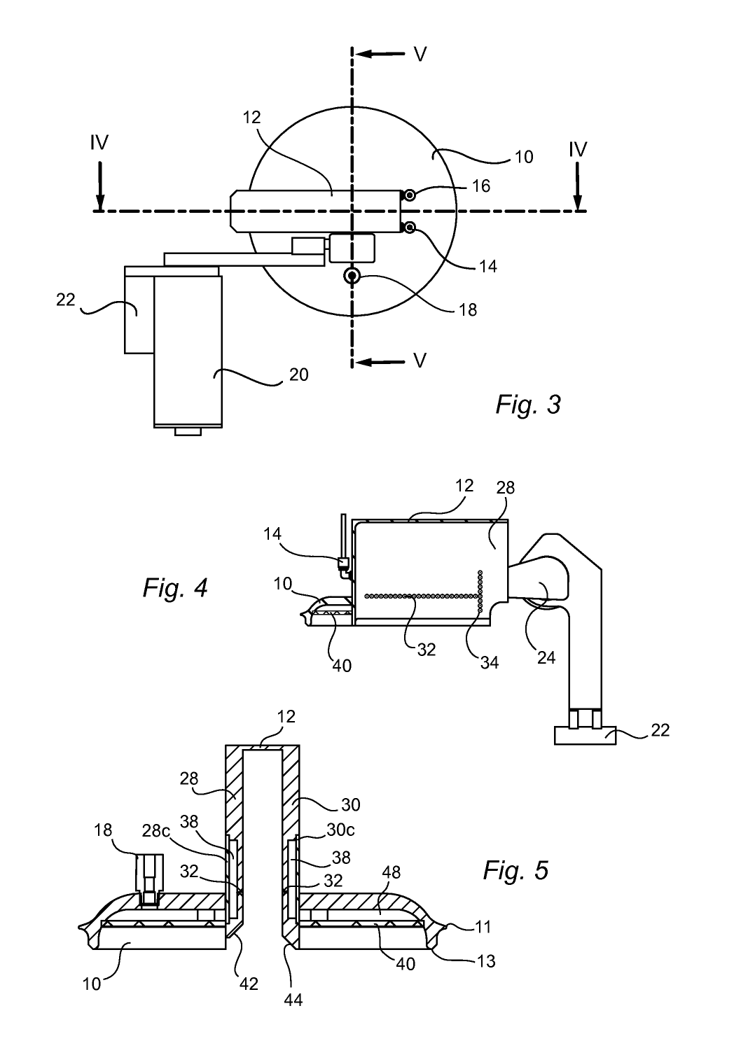

Turning now to FIGS. 3-5, several additional features of the gas supply device 10 of this embodiment are highlighted. In particular, FIG. 5 shows the plenum 32 in each wall 28, 30, which joins inlet 14, 16 with its respective array of outlets 32 formed on the interior faces of walls 28, 30. FIG. 5 also reveals that wall 28 in this embodiment is shorter than wall 30, by a distance of about 1 cm (in the case of a gas supply device designed for use with a chuck that handles 300 mm wafers), in order to produce an effect that will be described in connection with the use of the device.

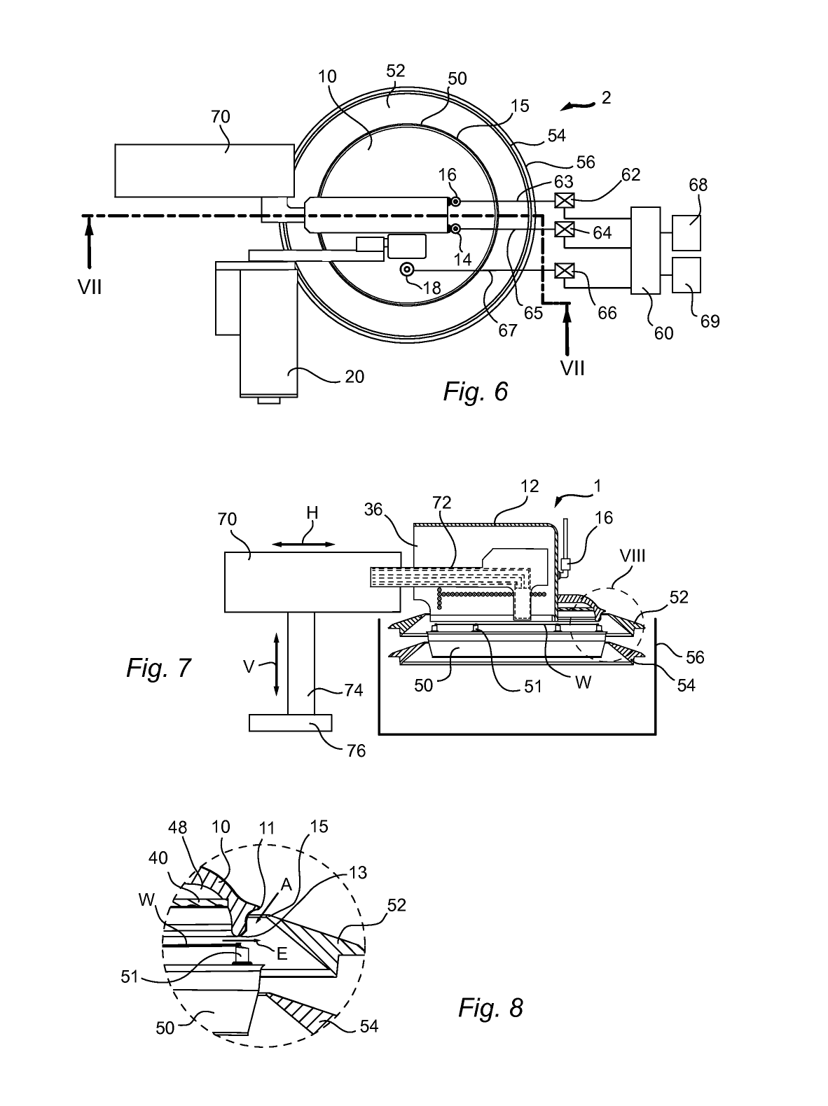

In FIGS. 6-8 the gas supply device 10 has been mounted in an apparatus 2 for processing semiconductor wafers. In particular, as can be seen in FIG. 7, the apparatus 2 includes a spin chuck 50 with a circular series of gripping pins 51 which together contact and support a semiconductor wafer W at its edge. Such a chuck 50 is therefore designed to handle a wafer of a predetermined diameter, with the recent and next generations of silicon wafers being 200 mm, 300 mm or 450 mm in diameter. Various conventional features of such a chuck are omitted for ease of understanding, such as the rotary shaft that spins the chuck 50 about its central axis, which is coincident with the axis of wafer W.

A particular fluid dispenser 70 is shown in conjunction with the apparatus 2, but it will be understood that additional undepicted fluid dispensers could be present, such as additional medium dispensers for the top side of wafer W, as well as conduits leading fluid media to the underside of wafer W, as are known to those of skill in this art.

Chuck 50 is shown surrounded by a collector 56 that includes a pair of deflectors 52, 54, although in practice at least three such deflectors will typically be used. Such coaxial superposed deflectors 53, 54 are characteristic of a multilevel chuck, in which chuck 50 is movable not only in rotation, but also vertically so as to be positioned at each of the collector levels. The various deflectors 52, 54 serve to direct spent process medium to different collector drains, thereby permitting a wider range of processes to be performed by a given chuck. Collector 56 also includes suitable ducts for handling exhaust gases from the apparatus 2.

This type of apparatus 2 is not provided in a sealed chamber, that is, ambient air may enter into the apparatus such as shown for example by arrow A in FIG. 8. Nevertheless, the gas supply device 10 provides a local non-oxidizing ambient atmosphere in the region immediately adjacent the wafer W, which prevents such corrosion of copper and cobalt structures formed on the wafer W as would otherwise occur due to diffusion of oxygen through the media such as deionized water dispensed onto the wafer W top surface. The ambient atmosphere drawn inside through the gap between the deflector 52 and the hood 10 will be mixed with the gas that is expelled from the chuck along the arrow E of FIG. 8 and then will be radially exhausted between deflectors 52 and 54.

FIG. 8 also illustrates that the gas supply hood 10 comprises at its outer periphery a spoiler 11, which defines the gap between the hood and the collector 56, and more particularly the inner edge 15 of deflector 52, which gap is preferably in the range of 0.3 mm to 5 mm. The gas supply hood 10 furthermore comprises a lower ring 13 that defines a gap between the hood 10 and the edge of a wafer W positioned on the chuck 50.

In this embodiment, the dispense arm 72 of a fluid dispenser 70 is received within the tunnel 12 of gas supply device 1, through the rear opening 36 of the same. Fluid dispenser 70 is mounted to the apparatus 2 by a base plate 76, via a shaft 74 so as to be movable via computer-controlled micromotors both horizontally in a reciprocal linear motion along arrows H and vertically along arrows V. The size and shape of tunnel 12 accommodates these motions of the dispense arm 72, while keeping dispense arm 72 covered by the gas hood 10. Internal conduits in dispense arm 72 in this embodiment supply deionized water as well as a vapor of isopropyl alcohol in nitrogen gas, so as to effect Marangoni drying of the upper surface of a spinning wafer W, as described more fully for example in the published International patent application WO 2008/041211.

Inlets 14, 16, 18 of gas supply device are connected to respective conduits 65, 63 and 67, which supply a non-oxidizing gas, preferably nitrogen, to each of those inlets. The nitrogen is provided from a supply 68, and the flow of nitrogen to the inlets 14, 16, 18 is controlled independently of one another by respective valves 64, 62, 66, which are in turn controlled by a microflow controller 60 as directed by overall operations computer 69.

In operation, the gas supply device is preferably operated before commencing operation of fluid dispenser 70, so as to effect a purge of the ambient atmosphere immediately adjacent wafer W as well as inside tunnel 12. Thus, nitrogen gas is supplied to each of inlets 14, 16, 18 as described above, at a flow rate toward the upper end of the preferred operating range of 50-300 l/min. Chuck 50 and wafer W may be stationary or in rotation during this purge.

After completing the purge, dispenser 70 is operated to perform a drying operation on wafer W. In particular, the Marangoni effect is utilized to generate an interface between deionized water and IPA vapor in nitrogen owing to the surface tension gradient between those fluids, and the interface is moved from the center of wafer W to its periphery by radial outward linear movement of the dispense arm 72 as the wafer is rotated. During this drying operation, nitrogen gas may be supplied to the gas supply device at a relatively lower flow rate, so as to maintain the non-oxidizing ambient adjacent the wafer surface, or the nitrogen flow may be discontinued.

Preferably, the nitrogen flow is continued at least to the inlets 14 and 16 which supply the outlets 32 and 34 in tunnel walls 28, 30. In particular, the opposing gas flows through the outlets 32 and 34 in tunnel walls 28, 30 serves as a continuing purge of the tunnel interior, and prevents oxygen from being drawn down into the region immediately adjacent the upper surface of wafer W. In particular, the opposing gas flows through the outlets 32 and 34 serve as a barrier against incoming oxygen.

The asymmetry of walls 28, 30 promotes maintaining a non-oxidizing atmosphere within tunnel 12. In particular, the shorter wall end 42 relative to the longer wall end 44, in combination with the rapidly spinning wafer W, creates a pumping effect within tunnel 12 that serves to force the ambient atmosphere outward through the open end 36 at the rear of tunnel 12.

Similarly, as shown in FIG. 8, the gas flow to inlet 18 is selected such that a positive pressure is maintained at the periphery of the gas hood 10. In this manner, non-oxidizing gas is discharged radially outwardly of the chuck 50 in the direction of arrow E, which acts as a barrier to air entering the region immediately adjacent the upper surface of wafer W.

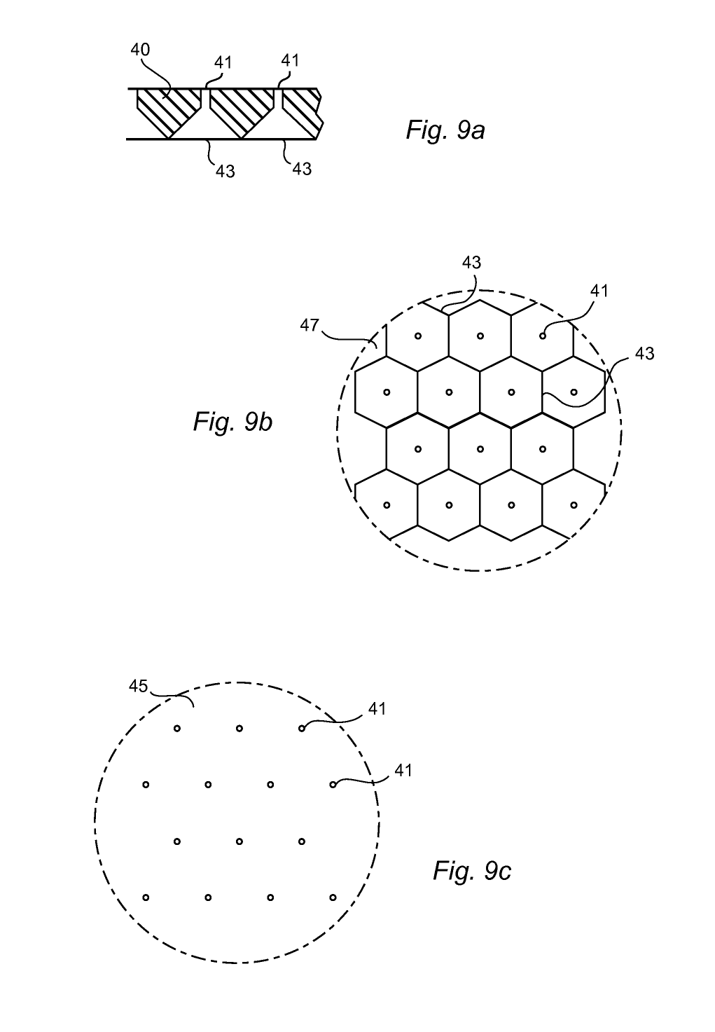

In FIGS. 9a-9c, a preferred configuration of showerhead 40 is shown. In particular, showerhead 40 preferably includes on its upstream face 45 an array of holes 41 that are relatively small in diameter, with a diameter of about 0.5 mm being preferred in the present embodiment. The upstream face 45 of showerhead 40 and the surrounding gas hood 10 define a plenum 48 upstream of showerhead 40, the plenum 48 being a pressure distribution chamber. The inlet holes progressively widen passing through the thickness of showerhead 40 from inlet side to outlet side, such that the outlets 43 are nearly contiguous and preferably are configured in a honeycomb pattern as shown in FIG. 9b.

This configuration of the showerhead 40 helps to maintain a desired positive pressure in the plenum 48 immediately upstream of the showerhead, and also assists in creating a turbulent low speed nitrogen flow which is optimum for exclusion of air from the surface of the wafer W.

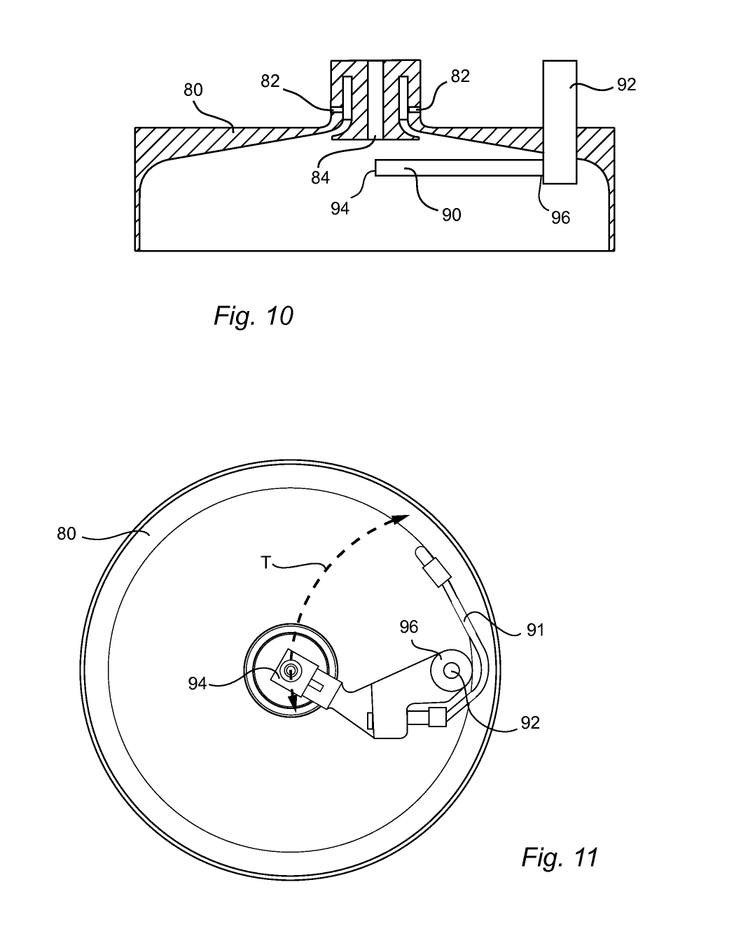

In FIGS. 10-13, another embodiment of the gas supply device is shown. The features illustrated are those which differ from the gas supply device of the preceding embodiment, whereas common features of the two embodiments are not described again.

As can be seen in FIG. 10, the gas hood 80 of this embodiment does not include a tunnel to accommodate an independently mounted fluid dispenser, but instead includes a fluid dispenser 90 that is mounted on the gas hood 80 itself. In particular, fluid dispenser 90 in this embodiment has a distal end 94 fitted with at least one nozzle for dispensing one or more fluids onto an upper surface of a wafer, as described in connection with the preceding embodiments. The proximal end 96 of fluid dispenser 90 is pivotally mounted to the underside of gas hood 80, and more particularly to the output shaft of a motor 92 that is mounted on the upper external surface of gas hood 80, and whose output shaft traverses the hood 80 via a dynamic seal.

Gas hood 80 preferably includes a central gas inlet 84 and side inlets 82, which are independently supplied with non-oxidizing gas as was described in connection with the preceding embodiments.

FIG. 11 shows the gas hood 80 from below, and the dispenser 90 in somewhat greater detail, including an associated fluid conduit 91, and the trajectory T of the nozzle at the distal end 94 of the dispenser 90 as it is pivoted at its proximal end 96 by the output shaft of motor 92.

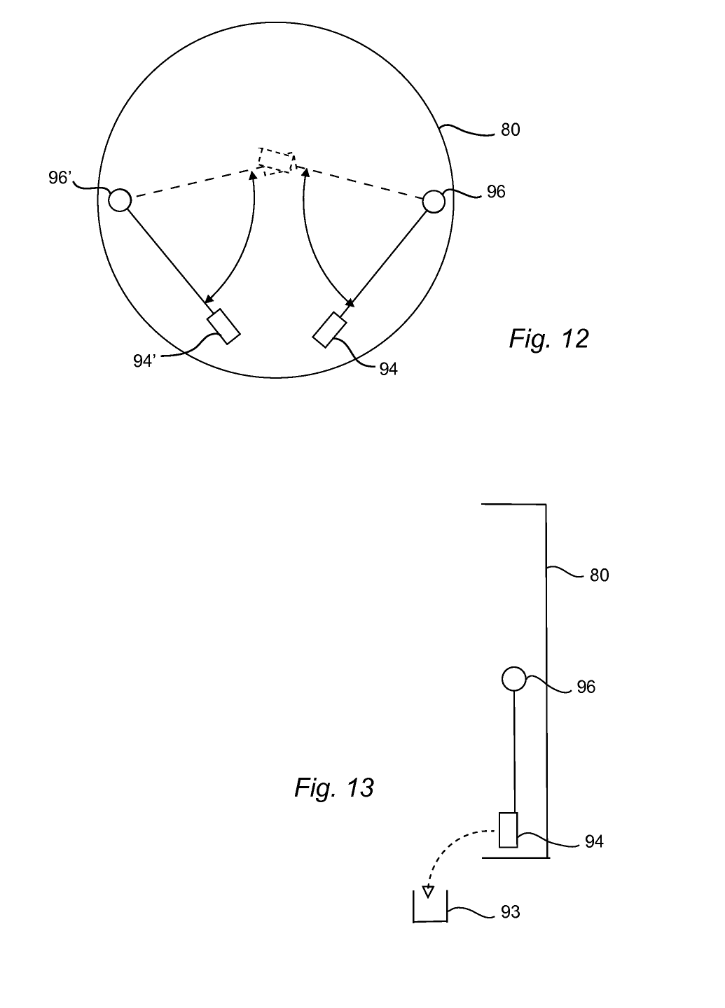

FIG. 12 is a schematic view similar to that of FIG. 11, of a still further embodiment of the gas hood, which differs from that of FIGS. 10 and 11 principally in that two fluid dispenser are mounted to the underside of the gas hood 80. Thus, the proximal end 96′ of the second fluid dispenser is pivotally mounted to the underside of hood 80 via second motor (not shown) mounted on the upper external side of hood 80, and its distal dispensing end 94′ is movable over a circular arc that is the approximate mirror image of the first fluid dispenser. This embodiment permits different fluids to be dispensed from the hood in a more flexible variety of process windows.

The embodiments of FIGS. 10-13, like the preceding embodiments include a gas hood that can be pivoted between a working position and a standby position, and FIG. 13 schematically depicts such a hood in the standby position. An additional feature of the embodiments of FIGS. 10-13 is that a preflush hopper 93 may be provided adjacent one or both of the outlet ends 94 of the fluid dispenser 90, to facilitate preflushing of the fluid dispensers before lowering the gas hood 80 to its working position.

The embodiments of FIGS. 10-13, like the preceding embodiments, provide a fluid dispenser that is contained within the gas hood of the gas supply device and which is movable relative to the gas hood while the gas hood is in its working position. The embodiments of FIGS. 10-13 might provide improved control of the atmosphere in the region immediately adjacent the upper surface of the wafer, because they do not include a tunnel with an open rear portion as in the preceding embodiments.

While the present invention has been described in connection with various illustrative embodiments thereof, it is to be understood that those embodiments should not be used as a pretext to limit the scope of protection conferred by the true scope and spirit of the appended claims.

What is claimed is:

1. Apparatus for treating a wafer-shaped article, comprising:
a holder for holding a wafer-shaped article of a predetermined diameter;
a fluid dispenser for dispensing at least one fluid onto an upper surface of a wafer shaped article positioned on the holder; and
a gas supply hood positionable in a working position above said holder wherein said gas supply hood covers all or substantially all of a wafer shaped article when positioned on said holder;
said gas supply hood accommodating said fluid dispenser within said gas supply hood and permitting said fluid dispenser to be moved laterally of said holder and said gas supply hood while said gas supply hood is in said working position and without moving said gas supply hood.

2. The apparatus according to claim 1, wherein said gas supply hood comprises a gas showerhead having an array of gas dispensing outlets directed downwardly toward a wafer-shaped article when position on said holder.

3. The apparatus according to claim 1, wherein said holder is a spin chuck in a process module for single wafer wet processing of semiconductor wafers.

4. The apparatus according to claim 1, further comprising a fluid collector surrounding said holder, and wherein said collector exposes said holder and said gas supply hood to ambient atmosphere.

5. The apparatus according to claim 1, wherein said gas supply hood is mounted for pivotal movement between said working position and a standby position.

6. The apparatus according to claim 1, wherein said gas supply hood further comprises a tunnel defined by a pair of walls whose upper ends are joined together and whose lower ends pass through a distribution plate of said gas showerhead,

7. The apparatus according to claim 3, wherein said fluid dispenser is mounted for lateral movement in a plane perpendicular to the axis of rotation of said spin chuck.

8. The apparatus according to claim 7, wherein said lateral movement is linear movement along a radial direction of said spin chuck.

9. The apparatus according to claim 7, wherein said lateral movement is swinging movement and said fluid dispenser comprises a proximal end mounted for pivotal movement about an axis parallel to and offset from the axis of rotation of said spin chuck and a distal end that is moveable over a circular arc.

10. A gas supply device for use in an apparatus for treating wafer-shaped articles of a predetermined diameter, comprising:
a gas hood of a size to cover all or substantially all of a wafer-shaped article when mounted on an apparatus for treating wafer-shaped articles and when in a working position;
a pivotal mounting for said gas hood that permits said gas hood to move between said working position and a standby position;
said gas supply hood being configured to receive a fluid dispenser within an outlet side of said gas hood such that the fluid dispenser is moveable laterally of said gas hood.

11. The gas supply hood according to claim 10, further comprising a tunnel projecting upwardly from said gas hood and configured to accommodate a fluid dispenser such that the fluid dispenser is linearly movable within said tunnel.

12. The gas supply hood according to claim 10, wherein said gas hood comprises a fluid dispenser pivotally mounted on an outlet side of said gas hood.

13. Method of treating a wafer-shaped article, comprising:
positioning a wafer-shaped article of a predetermined diameter on a holder;
positioning a gas supply hood in a working position above the holder wherein the gas supply hood covers all or substantially all of the wafer-shaped article positioned on the holder, and also covers a dispensing portion of a fluid dispenser for dispensing at least one fluid onto an upper surface of the wafer shaped article;
dispensing a non-oxidizing gas through the gas supply hood to purge a local ambient above the wafer-shaped article; and
moving the fluid dispenser laterally of the holder and the gas supply hood while maintaining the gas supply hood stationary relative to the holder.

14. The method according to claim 13, wherein the fluid dispenser is mounted independently of the gas supply hood, and is moved laterally along a linear path within a tunnel that projects upwardly from the gas supply hood.

15. The method according to claim 13, wherein non-oxidizing gas is dispensed from the gas supply hood during lateral movement of the fluid dispenser within the gas supply hood.
